(19) United States
(12) Patent Application Publication
(10) Pub. No.: US 2013/0009600 A1
(43) Pub. Date: Jan. 10, 2013

(54) ELECTRIC ENERGY STORAGE APPARATUS, VOLTAGE EQUALIZATION MODULE AND VOLTAGE EQUALIZATION METHOD

(75) Inventors: Young Hak Jeong, Gyeonggi-do (KR); Hyun Chul Jung, Gyeonggi-do (KR); Bae Kyun Kim, Gyeonggi-do (KR); Chan Yoon, Seoul (KR)

(73) Assignee: SAMSUNG ELECTRO-MECHANICS CO., LTD, Suwon (KR)

(21) Appl. No.: 13/478,725

(22) Filed: May 23, 2012

(30) Foreign Application Priority Data
Jul. 8, 2011 (KR) 10-2011-0067896

(51) Int. Cl. H02J 7/00

(52) U.S. Cl. 320/118; 320/167; 320/166

(57) ABSTRACT

Disclosed herein are an electric energy storage apparatus, a voltage equalization module thereof, and a voltage equalization method. There is provided an electric energy storage apparatus, including: a plurality of electric energy storage cells connected in series; voltage sensing units sensing voltage charged in each of the electric energy storage cells, respectively; first bypass discharge units connected to each of the electric energy storage cells in parallel, respectively, and bypassing and discharging electric energy charged; second bypass discharge units additionally connected to each of the electric energy storage cells in parallel, respectively, and bypassing and additionally discharging electric energy; and a control unit receiving voltage information from the voltage sensing units, determining whether controlling or not and controlling operations of each of the first and second bypass discharge units so as to equalize charged voltage values of the electric energy storage cells.

### CROSS REFERENCE(S) TO RELATED APPLICATIONS

This application claims the benefit under 35 U.S.C. Section 119 of Korean Patent Application Serial No. 10-2011-0067896, entitled “Electric Energy Storage Apparatus, Voltage Equalization Module THEREOF and Voltage Equalization Method” filed on Jul. 8, 2011, which is hereby incorporated by reference in its entirety into this application.

### BACKGROUND OF THE INVENTION

1. Technical Field

The present invention relates to an electric energy storage apparatus, a voltage equalization module thereof, and a voltage equalization method. More particularly, the present invention relates to an electric energy storage apparatus having two bypass discharge circuits to effectively implement voltage equalization at the time of high-speed charging and discharging, a voltage equalization module thereof, and a voltage equalization method.

2. Description of the Related Art

An example of a representative electric energy storage device may include a battery and a capacitor. Specifications of the capacitor, such as capacity, withstand voltage, frequency characteristics, leakage current, and internal resistance, or the like, may be determined according to a dielectric material. Various capacitors, such as a small-capacity capacitor used for a small-sized chip, a mid and large-capacity capacitor used for a power grid according to capacity and purpose have been used.

Recently, a supercapacitor as the mid and large-capacity capacitor has been in the limelight. The supercapacitor may be referred to as a supercapacitor, a super-high capacity capacitor, an ultracapacitor, or the like. The supercapacitor has advantages, such as very long charging and discharging lifespan, high charging and discharging efficiency, excellent performance deviation against a change in temperature, relatively low resistance and high-speed charging as compared with a secondary battery, or the like, and as a result, has been widely used for an electric car, a hydrogen fuel cell vehicle, a power supply for solar energy, an industrial power supply such as an uninterruptible power supply (UPS), or the like.

Meanwhile, apparatuses using the supercapacitor as the industrial power supply may require high voltage, such as several tens of voltage to several hundreds of voltage and therefore, use a plurality of supercapacitors having several voltages connected in series as an electric energy storage apparatus.

However, since the plurality of supercapacitors are connected in series, voltage deviation occurs between each unit cell and voltage between each cell is non-uniform due to capacitance deviation, initial voltage deviation, leakage current deviation, resistance deviation, deviation in capacitance reduction rate depending on used time, or the like, between each unit cell, that is, each supercapacitor. In particular, when voltage of each cell is out of an appropriate range, the lifespan of the cell is shortened or the cell is destroyed, thereby degrading the reliability of the electric energy storage apparatus.

In order to resolve the above-mentioned problem, various technologies for voltage equalization between each unit cell of the plurality of supercapacitors connected in series have been developed.

FIG. 5 is a diagram schematically showing an electric energy storage apparatus for voltage equalization of a supercapacitor according to the related art.

As shown in FIG. 5, a bypass resistor 5 is disposed in parallel at both ends of an electric energy storage cell 1 connected in series in an electric energy storage apparatus and a switch 3 connected to the bypass resistor 5 in series to short-circuit the bypass resistor 5 from both ends of each cell or open the bypass resistor 5 is disposed. Although not shown, the electric energy storage apparatus without the switch 3 may be configured according to a type. Therefore, when voltage at each cell 1 exceeds a set voltage, that is, when the supercapacitor 1 is overcharged, the switch 3 is turned-on so as to consume power overcharged in the supercapacitor 1 through the bypass resistor 5, thereby discharging overvoltage. Therefore, there is a need to appropriately maintain a voltage range of each cell 10.

### SUMMARY OF THE INVENTION

However, when high-speed charging is performed by the method according to the related art as shown in FIG. 5, the charge amount of the supercapacitor is increased. However, since the discharge amount is smaller than the charge amount, voltage equalization is slow and since the discharge amount is smaller than the charge amount even though the discharge is performed according to overcharging, overcharging of the supercapacitor 1 is continuously performed, thereby accelerating the deterioration of the supercapacitor 1.

An object of the present invention is to provide a voltage equalization circuit capable of preventing an operation from stopping and a malfunction of an electric energy storage cell, for example, a supercapacitor due to voltage unbalance between unit cells of the electric energy storage cell, for example, the supercapacitor.

According to an exemplary embodiment of the present invention, there is provided an electric energy storage apparatus, including: a plurality of electric energy storage cells connected in series; voltage sensing units sensing voltage charged in each of the electric energy storage cells, respectively; first bypass discharge units connected to each of the electric energy storage cells in parallel, respectively, and bypassing and discharging electric energy charged according to a control signal; second bypass discharge units additionally connected to each of the electric energy storage cells in parallel, respectively, and bypassing and additionally discharging electric energy, according to a control signal; and a control unit receiving voltage information from the voltage sensing units, determining whether controlling or not and controlling operations of each of the first and second bypass discharge units so as to equalize charged voltage values of the electric energy storage cells.

The control unit may control the first bypass discharge unit connected to the corresponding electric energy storage cell so as to perform the discharge when the value of the voltage information received from the voltage sensing unit is a reference voltage or more.

The control unit may control the additionally connected second bypass discharge unit so as to perform the additional discharge when voltage of the electric energy storage cell according to the discharge of the first bypass discharge unit has not dropped to a discharge releasing reference voltage or less.

The discharge releasing reference voltage may be an average charged voltage of the plurality of electric energy storage cells.

The first bypass discharge unit may include a switching device and a first discharge resistor.

The second bypass discharge unit may include a voltage detector and a second discharge resistor.

The first and second bypass discharge units may include a first discharge resistor and a second discharge resistor, respectively, as a discharge device, and any one resistance value of the first and second discharge resistors may be larger than that of the other one.

The first bypass discharge unit may include the switching device and the first discharge resistor, the second bypass discharge unit may include the voltage detector and the second discharge resistor, and the resistance value of the first discharge resistor may be larger than that of the second discharge resistor.

The electric energy storage cell may be a supercapacitor cell. According to another exemplary embodiment of the present invention, there is provided a voltage equalization module used in an electric energy storage apparatus including a plurality of electric energy storage cells connected in series and a control unit receiving voltage of the electric energy storage cells, determining controlling or not and performing a control so as to equalize voltage values of the electric energy storage cells, the voltage equalization module including: a voltage sensing unit individually sensing voltage charged in the electric energy storage cell; a first bypass discharge unit connected to the electric energy storage cell in parallel and bypassing electric energy charged in the electrical energy storage cell in which the charged voltage is a reference voltage or more and performing the discharge, according to a control signal of the control unit; and a second bypass discharge unit additionally connected to the electric energy storage cell in parallel and bypassing electric energy charged in the electrical energy storage cell in which the charged voltage has not dropped to the discharge releasing reference voltage or less after the discharge of the first bypass discharge unit and therefore performing the additional discharge, according to the control signal of the control unit.

The first bypass discharge unit may include a switching device and a first discharge resistor, and the second bypass discharge unit may include a voltage detector and a second discharge resistor.

The first and second bypass discharge units may include a first discharge resistor and a second discharge resistor, respectively, as a discharge device, and any one resistance value of the first and second discharge resistors may be larger than that of the other one.

The voltage equalization module may equalize the voltage of a supercapacitor cell.

According to another exemplary embodiment of the present invention, there is provided a voltage equalization method of an electric energy storage apparatus, including: charging a plurality of electric energy storage cells connected in series and sensing voltage charged in each of the electric energy storage cells; first performing bypass discharge by operating a first bypass discharge unit connected in parallel to the electric energy storage cells in which charged voltage is not equalized and is charged more than the reference voltage, as a sensed result; and second performing additional bypass discharge by operating the second bypass discharge unit additionally connected to the electric energy storage cell in parallel when the charged voltage of the electric energy storage cell has not dropped to the discharge releasing reference voltage or less after the first performing bypass discharge.

The discharge releasing reference voltage may be an average charged voltage of the plurality of electric energy storage cells.

The first bypass discharge unit may include a switching device and a first discharge resistor, and at the first performing bypass discharge, the discharge is performed by turning-on the switching device according to the control signal and consuming energy in the first discharge resistor.

The second bypass discharge unit may include a voltage detector and a second discharge resistor, and at the second performing bypass discharge, the discharge may be performed by operating the voltage detector according to the control signal and consuming energy in the second discharge resistor.

The first and second bypass discharge units may include a first discharge resistor and a second discharge resistor, respectively, as a discharge device, and any one resistance value of the first and second discharge resistors may be larger than that of the other one, such that instant discharge is greatly performed at the first or second performing bypass discharge.

The first bypass discharge unit may include a switching device and a first discharging resistor and the second bypass discharge unit includes a voltage detector and a second discharge resistor, and the first discharge resistor may have a larger resistance value than the second discharge resistance, such that instant discharge is greatly performed at the second performing bypass discharge.

The electric energy storage cell may be a supercapacitor cell.

Although not specifically stated as an aspect of the present invention, exemplary embodiments of the present invention according to possible various combinations of above-mentioned technical characteristics may be supported by the following specific exemplary embodiments and may be obviously implemented by those skilled in the art.

### BRIEF DESCRIPTION OF THE DRAWINGS

FIG. 1 is a block diagram schematically showing an electric energy storage apparatus according to an exemplary embodiment of the present invention.

FIG. 2 is a circuit diagram schematically showing an electric energy storage apparatus according to another exemplary embodiment of the present invention.

FIG. 3 is a circuit diagram schematically showing an electric energy storage apparatus according to another exemplary embodiment of the present invention.

FIG. 4 is a flow chart schematically showing a voltage equalization method of an electric energy storage apparatus according to another exemplary embodiment of the present invention.

FIG. 5 is a diagram schematically showing an electric energy storage apparatus for voltage equalization according to the related art.

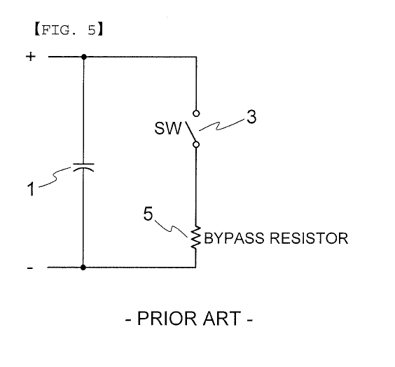

### DESCRIPTION OF THE PREFERRED EMBODIMENTS

Exemplary embodiments of the present invention for accomplishing the above-mentioned objects will be described with reference to the accompanying drawings. In describing exemplary embodiments of the present invention, the same reference numerals will be used to describe the same components and an additional description that is overlapped or allow the meaning of the present invention to be restrictively interpreted will be omitted.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Addition, in the specification, spatially relative terms, ‘on’, ‘above’, ‘upper’, ‘below’, ‘lower’, or the like, they should be interpreted as being in a ‘direct-contact’ shape or a shape in which other elements may be interposed therebetween, without a description that an element is in a ‘direct-contact’ with an object to be a basis. Furthermore, the spatially relative terms, ‘on’, ‘above’, ‘upper’, ‘below’, ‘lower’, or the like, may be used for describing a relationship of an element for another element. In this case, when a direction of the element to be a basis is reversed or changed, the spatially relative terms may include concept for directions of relative terms corresponding thereto.

Although a singular form is used in the present description, it may include a plural form as long as it is opposite to the concept of the present invention and is not contradictory in view of interpretation or is used as clearly a different meaning.

It should be understood that “include”, “have”, “comprise”, “be configured to include”, and the like, used in the present description do not exclude presence or addition of one or more other characteristic, component, or a combination thereof.

In the specification, charged voltage means a state in which voltage is charged or discharged in an electric energy storage cell or/and voltage of the electric energy storage cell in other cases and is not construed as being limited to voltage that is being charged.

First, an electric energy storage apparatus according to an exemplary embodiment of the present invention will be described with reference to the accompanying drawings.

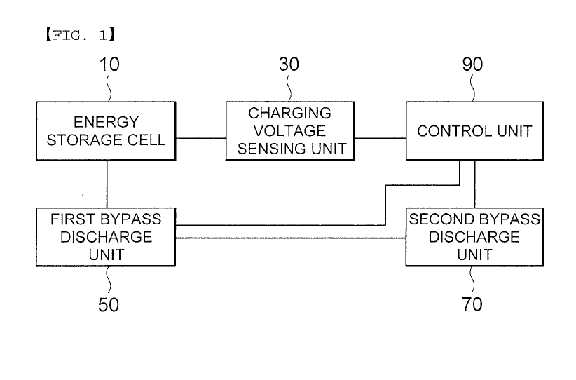

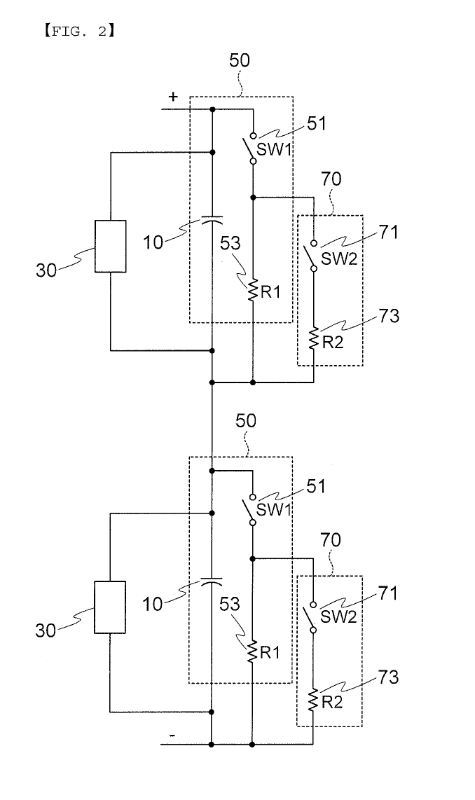

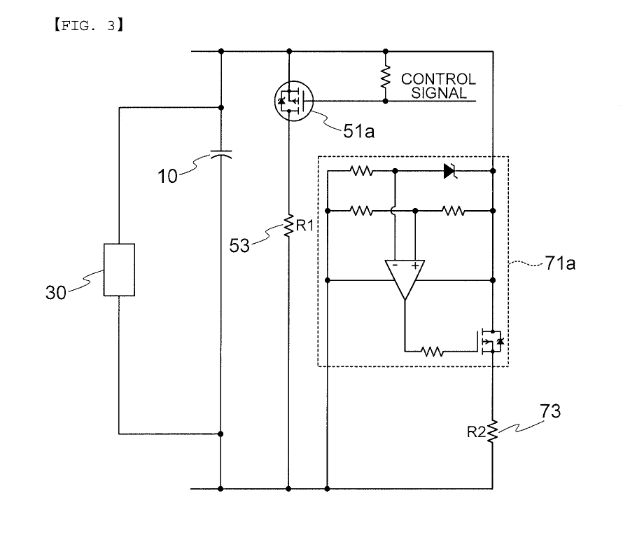

FIG. 1 is a block diagram schematically showing an electric energy storage apparatus according to an exemplary embodiment of the present invention. FIG. 2 is a circuit diagram schematically showing an electric energy storage apparatus according to another exemplary embodiment of the present invention. FIG. 3 is a circuit diagram schematically showing an electric energy storage apparatus according to another exemplary embodiment of the present invention.

An exemplary embodiment of the present invention will be described with reference to FIGS. 1 to 3.

Referring to FIG. 1, an exemplary embodiment of an electric energy storage apparatus is configured to include an electric energy storage cell 10, a voltage sensing unit 30, a first bypass discharge unit 50, a second bypass discharge unit 70, and a control unit 90. The exemplary embodiment of the present invention includes the first and second bypass discharge units 50 and 70 separately connected with to the electric energy storage cell 10 in parallel and two bypass lines. In the exemplary embodiment of the present invention, the first and second discharge units 50 and 70, which configure a voltage equalization circuit, uniformly maintains voltage so as to prevent an operation from stopping and a malfunction, a risk of an explosion, or the like, of the electric energy storage apparatus and the electric energy storage cell 10, for example, the supercapacitor at the time of the overvoltage of the electric energy storage apparatus and the electric energy storage cell 10, for example, the supercapacitor.

Describing in more detail, the electric energy storage cell 10 is configured in plural, which are connected in series. The electric energy storage cell 10 is a device in which electric energy is charged. An example of the device may include a secondary battery, a supercapacitor, or the like. The present invention relates to voltage equalization and therefore, as an example of the electric energy storage cell 10 of the exemplary embodiment of the present invention, the supercapacitor device may be more preferable than the secondary battery. The supercapacitor 10 according to the exemplary embodiment of the present invention is to be construed as a concept including all the devices called a supercapacitor, a super-high capacity capacitor, or an ultracapacitor in the art. An electric double layer capacitor or a similar capacitor may also be included in a concept of the supercapacitor.

As an example, the electric energy storage cell 10 is a supercapacitor cell.

Next, referring to FIGS. 1 to 3, the voltage sensing units 30 senses voltage charged in each of the electric energy storage cells 10, respectively. As the voltage sensing unit 30, a device capable of sensing the voltage charged in the electric energy storage cell 10 may be used. For example, an arithmetic amplifier (not shown) that transfers the voltage of the electric energy storage cell 10 to the control unit 90 may be an example of the voltage sensing unit 30 and a comparator (not shown) transferring comparison information obtained by comparing reference voltage with the voltage of the electric energy storage cell 10 may be another example. As the example, the arithmetic amplifier (not shown) may be used as the voltage sensing unit 30.

Referring to FIGS. 1 to 3, the first bypass discharge units 50 are connected with each of the electric energy storage cells 10 in parallel, respectively. The first bypass discharge unit 50 bypasses the electric energy charged in the electric energy storage cell 10 according to a control signal from the control unit 90 and discharges the electric energy.

Referring to FIGS. 2 and/or 3, in another exemplary embodiment of the present invention, the first bypass discharge unit 50 is configured to include switching devices 51 and 51a and a first discharge resistor 53. Referring to FIG. 3, the switching device 51a is an MOSFET. The MOSFET may be switched at higher speed than switching devices such as BJT, IGBT, or the like, and therefore, may be appropriately used as an instant discharge switch.

Referring to FIGS. 1 to 3, the second bypass discharge units 70 are further connected with each of the electric energy storage cells 10 in parallel, respectively. The second bypass discharge unit 70 bypasses the electric energy charged in the electric energy storage cell 10 according to the control signal from the control unit 90 and additionally discharges electric energy.

Referring to FIG. 2, in one example, the second bypass discharge unit 70 is configured to include a switching device 71 and a second discharge resistor 73. In this configuration, the switching device 71 serves to bypass current to the second discharge resistor 73. In one example, the switching device 71 of the second bypass discharge unit 70 may be a MOSFET device such as the first bypass discharge unit 50. As another example, a device or a module performing a switching function bypassing current to the second discharge resistor 73 may be the switching devices 71 and 71a of the second bypass discharge unit 70. In one example, a voltage detector 71a of FIG. 3 may be the switching device 71 of the second bypass discharge unit 70.

Referring to FIG. 3, in one exemplary embodiment of the present invention, the second bypass discharge unit 70 is configured to include the voltage detector 71a and the second discharge resistor 73. Output is supplied to the second discharge resistor 73 according to the voltage sensed in the voltage detector 71a, thereby performing the switching function.

In the exemplary embodiment of the present invention with reference to FIGS. 1 to 3, simply describing the operation of the exemplary embodiment of the present invention, when the voltage of the electric energy storage cell 10, for example, the supercapacitor 10 is monitored in the voltage sensing unit 30 and then, the sensed voltage or voltage information reaches the operation value of the first bypass discharge unit 50, the bypass current flows, for example, through the first discharge resistor 53 by operating the first bypass discharge unit 50, for example, the switching devices 51 and 51a of the first bypass discharge unit 50, i.e., the MOSFET according to the control signal of the control unit 90. As a result, the voltage of the electric energy storage cell 10, for example, the supercapacitor connected to the first bypass discharge unit 50 drops and is equalized to the voltage of the remaining electric energy storage cells 10, for example, the supercapacitors or is in the equalization range of the remaining electric energy storage cells 10.

In this case, the amount of electric energy charged in the electric energy storage cell 10, for example, the supercapacitor may be larger than the amount discharged through the first bypass discharge unit 50. In this case, the exemplary embodiment of the present invention makes the charge amount larger than the discharge amount, thereby resolving the problem that the electric energy storage cell 10, for example, the supercapacitor is overcharged.

In this case, the exemplary embodiment of the present invention, when the voltage of the electric energy storage cell 10, for example, the supercapacitor 10 does not fall to the bypass circuit operation releasing value, for example, when the voltage of the electric energy storage cell 10, for example, the supercapacitor continuously rises, the second bypass discharge unit 70, for example, the switch of the first bypass discharge unit 50 or, for example, the voltage detector in FIG. 3 is operated according to the control of the control unit 90 to move current to the second bypass discharge unit 70. As a result, the voltage of the electric energy storage cell 10, for example, the supercapacitor connected to the first and second bypass discharge units 50 and 70 drops according to the additional discharge of the second bypass discharge unit 70 and is equalized to the voltage of the remaining electric energy storage cells 10, for example, the supercapacitors or is in the equalization range of the remaining electric energy storage cells 10.

Referring to FIGS. 2 and/or 3, another exemplary embodiment of the present invention will be described.

According to the exemplary embodiment of the present invention, the first and second bypass discharge units 50 and 70 include the first discharge resistor 53 and the second discharge resistor 73, respectively, as the discharge device. In this case, the resistance value ratio of the first discharge resistor 53 and the second discharge resistor 73 may be controlled according to product characteristics. That is, the first and second discharge resistors 53 and 73 may have the same resistance value. Preferably, in one example, any one resistance value of the first and second discharge resistors 53 and 73 is larger than that of the other one thereof since quicker instant charge and discharge are required in some cases. For example, when the resistance value of the second discharge resistor 73 is small, a larger amount of energy is consumed in the second discharge resistor 73, such that the discharge may be more rapidly performed in the second bypass discharge unit 70 than in the first bypass discharge unit 50. That is, even when the discharge is performed in the first bypass discharge unit 50, the discharge may be more rapidly performed through the second bypass discharge unit 70 when the charge amount charged in the electric energy storage cell 10 is more increased than the discharge amount. To the contrary, the discharge may be more rapidly performed in the first bypass discharge unit 50. In this case, the second bypass discharge unit 70 simply serves to increase the discharge capacity of the first bypass discharge unit 50 and the first bypass discharge unit 50 performs the main discharge. For example, the electric energy storage apparatus may be applied when there is a need to perform very rapid discharge processing.

Preferably, the discharge is more rapidly performed in the second bypass discharge unit 70 by making the resistance value of the second discharge resistor 73 smaller than that of the first discharge resistor 53. The electric energy storage apparatus may be considered to be more appropriate. In applications requiring high-speed charging and discharging, large current may flow through the second discharge resistor 73 by making the resistance value of the second discharge resistor 73 smaller than that the first discharge resistor 53. Therefore, the electric energy storage apparatus is appropriate for both of high-speed charging and high-speed discharging.

Describing the exemplary embodiment of the present invention with reference to FIG. 3, the first bypass discharge unit 50 is configured to include the switching device 51 and the first discharge resistor 53 and the second bypass discharge unit 70 is configured to include the voltage detector 71a and the second discharge resistor 73. As one example, the resistance value of the first discharge resistor 53 is larger than that of the second discharge resistor 73. Therefore, when the electric energy amount charged in the electric energy storage cell 10 is larger than the energy discharged from the first bypass discharge unit 50, the discharge may be more rapidly performed through the second bypass discharge unit 70.

The configuration of the control unit 90 will be described with reference to FIG. 1 again. The control unit 90 receives the voltage information from the voltage sensing units 30 and determines whether controlling or not. In this case, the control unit 90 controls the operation of the first bypass discharge units 50 or each of the first and second bypass discharge units 50 and 70 connected to each of the electric energy storage cells 10, respectively, so as to equalize the charged voltage values of the electric energy storage cells 10.

According to the exemplary embodiment of the present invention, the control unit 90 discharges the electric energy by controlling the first bypass discharge unit 50 connected to the corresponding electric energy storage cell 10 if it is determined that the voltage information received from the voltage sensing unit 30 is a reference voltage or more. In this case, in one example, the reference voltage may be an average charged voltage of the plurality of electric energy storage cells 10. In another example, a minimum voltage in the voltage of the plurality of electric energy storage cells 10 may be a reference voltage or voltage increased by a predetermined range from the minimum voltage may be a reference voltage. In order to meet the purpose of the electric energy storage apparatus, when equalization within an appropriate tolerance is performed, those skilled in the art may set the appropriate reference voltage so as to meet thereto.

In addition, according to the exemplary embodiment of the present invention, the control unit 90 performs the additional discharge by controlling the second bypass discharge unit 70 additionally connected when the voltage of the electric energy storage cell 10 has not dropped to the discharge releasing reference voltage or less due to the discharge of the first bypass discharge unit 50. In this case, in one example, the average charged voltage of the plurality of electric energy storage cells 10 becomes the discharge releasing reference voltage. In order to meet the purpose of the electric energy storage apparatus, when equalization within an appropriate tolerance is performed, those skilled in the art may set the appropriate discharge releasing reference voltage so as to meet thereto.

Next, the voltage equalization module used in the electric energy storage apparatus according to the exemplary embodiment of the present invention will be described. In describing the voltage equalization module according to the exemplary embodiment of the present invention, the exemplary embodiments of the above-mentioned electric energy storage apparatus will be described with reference to FIGS. 1 to 3. Therefore, the modifications according to the possible combination of the configurations described in the exemplary embodiments of the above-mentioned electric energy storage apparatus may be performed and the modifications are included in the exemplary embodiments of the voltage equalization module according to the exemplary embodiment of the present invention. In this case, any repeated description may be omitted in the exemplary embodiments of the above-mentioned electric energy storage apparatus.

The voltage equalization module applied to the electric energy storage apparatus will be described with reference to FIGS. 1 to 3. The voltage equalization module according to the exemplary embodiment of the present invention is applied to the electric energy storage apparatus including the plurality of electric energy storage cells 10 connected in series and the control unit 90 that receives the voltage information of the plurality of electric energy storage cells 10, determines whether controlling or not and performs a control to equalize the voltage values of the electric energy storage cells 10.

In this case, the voltage equalization module according to the exemplary embodiment of the present invention is configured to include the voltage sensing unit 30, the first bypass discharge unit 50, and the second bypass discharge unit 70. In this configuration, the voltage equalization module according to the exemplary embodiment of the present invention is to equalize the voltage of the supercapacitor cell.

In the exemplary embodiment of the present invention, the voltage sensing unit 30 senses the voltage charged in the electric energy storage cell 10.

Further, the first bypass discharge unit 50 is connected to the electric energy storage cell 10 in parallel. In this case, the first bypass discharge unit 50 bypasses the electric energy charged in the electric energy storage cell 10 in which the charged voltage is the reference voltage or more and performs the discharge, according to a control signal from the control unit 90 of the electric energy storage apparatus.

In addition, according to another exemplary embodiment of the present invention, the first bypass discharge unit 50 is configured to include the switching devices 51 and 51a and the first discharge resistor 53. In this case, the switching devices 51 and 51a may be the MOSFET.

Further, the second bypass discharge unit 70 is further connected to the electric energy storage cell 10 in parallel. In this case, the second bypass discharge unit 70 bypasses the electric energy charged in the electric energy storage cell 10 in which the charged voltage has not dropped to the discharge releasing reference voltage or less after the discharge of the first bypass discharge unit 50 and performs the additional discharge, according to the control signal of the control unit 90.

According to one exemplary embodiment of the present invention, the second bypass discharge unit 70 is configured to include the voltage detector 71a and the second discharge resistor 73.

In addition, describing another exemplary embodiment of the present invention, the first and second bypass discharge units 50 and 70 each include the first discharge resistor 53 and the second discharge resistor 73, respectively, as the discharge device. In this case, any one resistance value of the first and second discharge resistors 53 and 73 is larger than that of the other one. More preferably, the discharge may be more rapidly performed in the second bypass discharge unit 70 by making the resistance value of the second discharge resistor 73 smaller than that of the first discharge resistor 53.

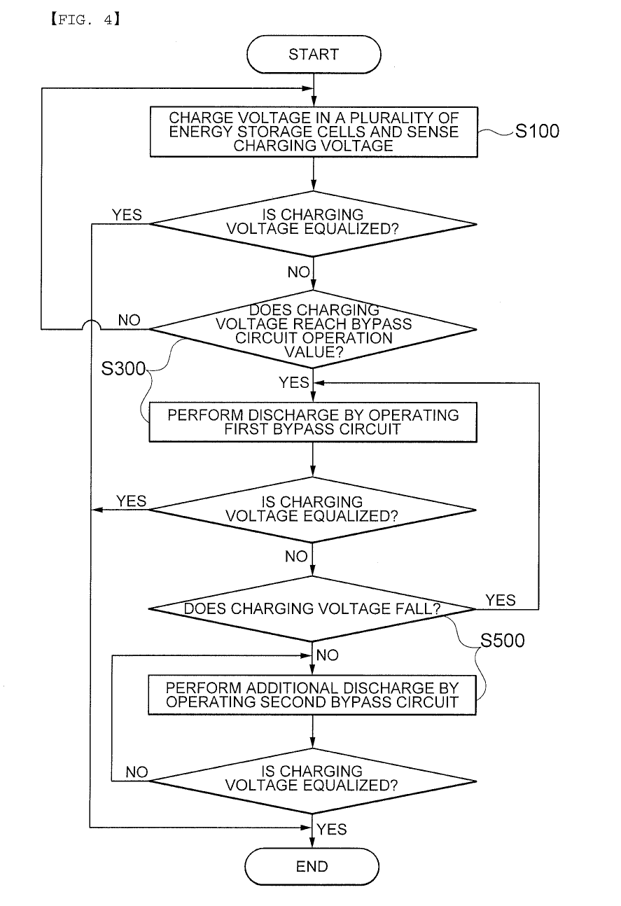

Next, the operation of the electric energy storage apparatus or/and the voltage equalization module according to the exemplary embodiment of the present invention the voltage equalization method of the electric energy storage apparatus according to the exemplary embodiment of the present invention will be described with reference to the accompanying drawings. The voltage equalization method of the electric energy storage apparatus according to the exemplary embodiment of the present invention will be described with reference to FIG. 4, the exemplary embodiments of the electric energy storage apparatus or/and the voltage equalization module, and FIGS. 1 to 3. Therefore, the repeated portion with the description in the exemplary embodiments of the present invention of the above-mentioned electric energy storage apparatus or/and the voltage equalization module may be omitted.

FIG. 4 is a flow chart schematically showing the voltage equalization method of the electric energy storage apparatus according to another exemplary embodiment of the present invention.

Referring to FIG. 4, the voltage equalization method of the electric energy storage apparatus according to the exemplary embodiment of the present invention is configured to include charging and sensing (S100), first performing bypass discharge (s300), and second performing bypass discharge (s500).

In detail, at the charging and sensing (S100), the plurality of electric energy storage cells 10 connected in series is charged. In this case, the voltage charged in each of the electric energy storage cell 10 is sensed.

According to the exemplary embodiment of the present invention, the electric energy storage cell 10 is a supercapacitor cell.

Next, describing the first performing bypass discharge (s300), as a sensed result at charging and sensing (S100), when the charged voltage is not equalized and the electric energy storage cell 100 in which the reference voltage or more is charged is present, the first bypass discharge unit 50 connected to the corresponding electric energy storage cell 10 in parallel is operated and then the discharge is performed.

In addition, according to another exemplary embodiment of the present invention, the first bypass discharge unit 50 is configured to include the switching device 51 and the first discharge resistor 53. In this configuration, at the first performing bypass discharge (S300), the discharge is performed by turning-on the switching device 51 according to the control signal and consuming the energy in the first discharge resistor 53.

Further, describing the second performing bypass discharge (s500) of FIG. 4, after the discharge is performed at the first performing bypass discharge (S300), when the charged voltage of the electric energy storage cell 10 after the first performing bypass discharge has not dropped to the discharge releasing reference voltage or less, the second bypass discharge unit 70 additionally connected to the corresponding electric energy storage cell 10 in parallel is operated to perform the additional discharge.

In addition, according to the exemplary embodiment of the present invention, the discharge releasing reference voltage is an average charged voltage of the plurality of electric energy storage cells 10.

In addition, according to one exemplary embodiment of the present invention, the second bypass discharge unit 70 is configured to include the voltage detector 71a and the second discharge resistor 73. In this configuration, the discharge is performed by operating the voltage detector 71a according to the control signal at the second performing bypass discharge and consuming the energy in the second discharge resistor 73.

Another exemplary embodiment of the method according to the present invention will be described. According to the exemplary embodiment of the present invention, the first and second bypass discharge units 50 and 70 include the first discharge resistor 53 and the second discharge resistor 73 as the discharge device. In this case, any one resistance value of the first and second discharge resistors 53 and 73 is larger than that of the other one. Therefore, at the first or second performing bypass discharge (S300 and S500), the instant discharge is performed.

According to another exemplary embodiment of the present invention, the first bypass discharge unit 50 is configured to include the switching device 51 and the first discharge resistor 53 and the second bypass discharge unit 70 is configured to include the voltage detector 71a and the second discharge resistor 73. In this case, the first discharge resistor 53 has a larger resistance value than the second discharge resistor 73. Therefore, at the second performing bypass discharge, the instant discharge is performed.

As set forth above, the exemplary embodiment of the present invention can provide the voltage equalization circuit and the voltage equalization method capable of preventing the operation of the supercapacitor from stopping and a malfunction in the electric energy storage cell due to the voltage unbalance between the unit cells of the supercapacitor.

The exemplary embodiment of the present invention includes the two bypass lines to move the bypass current to only the first bypass line or the first and second bypass lines according to the voltage of the electric energy storage cell, for example, the supercapacitor, thereby effectively implementing the voltage equalization. That is, the exemplary embodiment of the present invention can more rapidly implement voltage equalization than the related art, thereby increasing the reliability of the electric energy storage apparatus or the electric energy storage cell, for example, the supercapacitor.

In addition, the exemplary embodiment of the present invention can rapidly move a large amount of current through the second bypass line when making the second bypass resistance smaller than the first bypass resistance to greatly increase the voltage of the electric energy storage cell, for example, the supercapacitor, thereby stabilizing the voltage at the time much earlier than the related art and improving the reliability of the electric energy storage cell, for example, the supercapacitor.

It is obvious that various effects directly stated according to various exemplary embodiment of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. An electric energy storage apparatus, comprising:
a plurality of electric energy storage cells connected in series;
voltage sensing units sensing voltage charged in each of the electric energy storage cells, respectively;
first bypass discharge units connected to each of the electric energy storage cells in parallel, respectively, and bypassing and discharging electric energy charged according to a control signal;
second bypass discharge units additionally connected to each of the electric energy storage cells in parallel, respectively, and bypassing and additionally discharging electric energy, according to a control signal; and
a control unit receiving voltage information from the voltage sensing units, determining whether controlling or not and controlling operations of each of the first and second bypass discharge units so as to equalize charged voltage values of the electric energy storage cells.

2. The electric energy storage apparatus according to claim 1, wherein the control unit controls the first bypass discharge unit connected to the corresponding electric energy storage cell so as to perform the discharge when the value of the voltage information received from the voltage sensing unit is a reference voltage or more.

3. The electric energy storage apparatus according to claim 2, wherein the control unit controls the additionally connected second bypass discharge unit so as to perform the additional discharge when voltage of the electric energy storage cell according to the discharge of the first bypass discharge unit has not dropped to a discharge releasing reference voltage or less.

4. The electric energy storage apparatus according to claim 3, wherein the discharge releasing reference voltage is an average charged voltage of the plurality of electric energy storage cells.

5. The electric energy storage apparatus according to claim 1, wherein the first bypass discharge unit includes a switching device and a first discharge resistor.

6. The electric energy storage apparatus according to claim 1, wherein the second bypass discharge unit includes a voltage detector and a second discharge resistor.

7. The electric energy storage apparatus according to claim 1, wherein the first and second bypass discharge units include a first discharge resistor and a second discharge resistor, respectively, as a discharge device, and
any one resistance value of the first and second discharge resistors is larger than that of the other one.

8. The electric energy storage apparatus according to claim 7, wherein the first bypass discharge unit includes the switching device and the first discharge resistor,
the second bypass discharge unit includes the voltage detector and the second discharge resistor, and
the resistance value of the first discharge resistor is larger than that of the second discharge resistor.

9. The electric energy storage apparatus according to claim 1, wherein the electric energy storage cell is a supercapacitor cell.

10. A voltage equalization module used in an electric energy storage apparatus including a plurality of electric energy storage cells connected in series and a control unit receiving voltage of the electric energy storage cells, determining controlling or not and performing a control so as to equalize voltage values of the electric energy storage cells, the voltage equalization module comprising:
a voltage sensing unit individually sensing voltage charged in the electric energy storage cell;
a first bypass discharge unit connected to the electric energy storage cell in parallel and bypassing electric energy charged in the electrical energy storage cell in which the charged voltage is a reference voltage or more and performing the discharge, according to a control signal of the control unit; and
a second bypass discharge unit additionally connected to the electric energy storage cell in parallel and bypassing electric energy charged in the electrical energy storage cell in which the charged voltage has not dropped to the discharge releasing reference voltage or less after the discharge of the first bypass discharge unit and therefore performing the additional discharge, according to the control signal of the control unit.

11. The voltage equalization module according to claim 10, wherein the first bypass discharge unit includes a switching device and a first discharge resistor, and
the second bypass discharge unit includes a voltage detector and a second discharge resistor.

12. The voltage equalization module according to claim 10, wherein the first and second bypass discharge units include a first discharge resistor and a second discharge resistor, respectively, as a discharge device, and
any one resistance value of the first and second discharge resistors is larger than that of the other one.

13. The voltage equalization module according to claim 10, wherein the voltage equalization module equalizes voltage of a supercapacitor cell.

14. A voltage equalization method of an electric energy storage apparatus, comprising:
charging a plurality of electric energy storage cells connected in series and sensing voltage charged in each of the electric energy storage cells;
first performing bypass discharge by operating a first bypass discharge unit connected in parallel to the electric energy storage cells in which charged voltage is not equalized and is charged more than the reference voltage, as a sensed result; and
second performing additional bypass discharge by operating the second bypass discharge unit additionally connected to the electric energy storage cell in parallel when the charged voltage of the electric energy storage cell has not dropped to the discharge releasing reference voltage or less after the first performing bypass discharge.

15. The voltage equalization method according to claim 14, wherein the discharge releasing reference voltage is an average charged voltage of the plurality of electric energy storage cells.

16. The voltage equalization method according to claim 14, wherein the first bypass discharge unit includes a switching device and a first discharge resistor, and
at the first performing bypass discharge, the discharge is performed by turning-on the switching device according to the control signal and consuming energy in the first discharge resistor.

17. The voltage equalization method according to claim 14, wherein the second bypass discharge unit includes a voltage detector and a second discharge resistor, and
at the second performing bypass discharge, the discharge is performed by operating the voltage detector according to the control signal and consuming energy in the second discharge resistor.

18. The voltage equalization method according to claim 14, wherein the first and second bypass discharge units include a first discharge resistor and a second discharge resistor, respectively, as a discharge device, and
any one resistance value of the first and second discharge resistors is larger than that of the other one, such that instant discharge is greatly made at the first or second performing bypass discharge.

19. The voltage equalization method according to claim 18, wherein the first bypass discharge unit includes a switching device and a first discharging resistor and the second bypass discharge unit includes a voltage detector and a second discharge resistor, and
the first discharge resistor has a larger resistance value than the second discharge resistance, such that instant discharge is greatly made at the second performing bypass discharge.

20. The voltage equalization method according to claim 14, wherein the electric energy storage cell is a supercapacitor cell.
